(19) United States
(12) Patent Application Publication
(10) Pub. No.: US 2026/0303257 A1
(43) Pub. Date: Oct. 1, 2026

(54) RECEIVER FOR DIRECT-TO-DEVICE CONNECTIVITY VIA A SATELLITE SWARM

(71) Applicant: Hughes Network Systems, LLC, Germantown, MD (US)

(72) Inventor: Bassel F. BEIDAS, Alexandria, VA (US)

(73) Assignee: Hughes Network Systems, LLC, Germantown, MD (US)

(21) Appl. No.: 19/096,635

(22) Filed: Mar. 31, 2025

(51) Int. Cl. H04L 1/00; H04B 1/10; H04B 7/185

(52) U.S. Cl. CPC H04L 1/0048; H04B 1/10; H04B 7/18513

(57) ABSTRACT

A system and method for mitigating intra-beam interference including: receiving a desired beam and interfering beams transmitted by a satellite swarm; dividing the interfering beams into an intense set, a strong set, and a noise-floor set based on intensity of the interfering beams to mitigate intra-beam interference; decoding symbols from the strong set into a subtractive-cancellation set and the intense set into an optimal-Bayesian set; subtracting symbols of the subtractive-cancellation set; and addressing symbols of the optimal-Bayesian set in an optimal-Bayesian fashion, wherein the desired beam and the interfering beams comprise an Orthogonal Frequency-Division Multiplexing (OFDM) transmission precoded with beamforming weights. A system and method for beamforming at a satellite swarm by realizing a distributed array to jointly generate beams aimed at selected coverage areas is also described.

### FIELD

The present teachings relate to next-generation satellite systems that provide reliable connectivity directly to handheld smartphones or tablets having low-power omnidirectional antennas. Direct-to-Device (D2D) connectivity may be provided using a swarm of small, lightweight satellites hosting onboard a subarray holding a subset of the radiating elements to realize a distributed phased array antenna. The satellite or satellite swarm may be in a low Earth orbit. The connectivity may be provided using Orthogonal Frequency-Division Multiplexing (OFDM) transmission in the S-band over hundreds of kilometers. Inter-satellite links (ISLs) within the satellite swarm provide synchronization to realize joint transmission as a massive Multi-Input Multi-Output (MIMO) architecture in space based on a distributed subarray formulation. The satellite swarm is sometimes referred to as a distributed, decentralized, fractionated, or federated satellite system.

### BACKGROUND OF THE INVENTION

The prior art uses a conventional centralized large satellite hosting a large number of radiating elements to provide D2D connectivity. Some prior art uses distributed satellite systems involving swarms of small satellites as an alternative to deploying a conventional centralized large satellite. However, distributed swarm systems create interference-inducing grating lobes. Other prior art describes modifying a satellite swarm formation geometry to mitigate the grating lobes when full spectrum reuse is not used in adjacent beams. As such, the prior art does not provide sufficient suppression of the grating lobes when combined with full frequency reuse. Moreover, the prior art grating-lobe mitigation is less effective when the number of satellites in the swarms is reduced for near-term feasibility.

Direct-to-device (D2D) connectivity between satellites and handheld terrestrial devices, such as cellular User Equipment (UE), is a feature of next-generation non-terrestrial networks (NTNs). The next generation NTNs aim to provide ubiquitous anytime connectivity available anywhere on Earth, especially in areas where terrestrial infrastructure is lacking. Challenges include the large distance between a satellite and the terrestrial devices, and the low-power omnidirectional antennas employed in terrestrial devices, such as, smartphones and tablets. Current satellite systems utilize Low-Earth Orbit (LEO) satellites and lower frequency bands (UHF/L/S) to improve a link budget. Also, centralized satellites with a huge surface area for very large phased-array antennas are used to achieve a massive gain needed in overcoming the propagation loss. These very large phased-array antennas that include thousands of active radiating elements.

However, the problem of grating lobes arises in distributed satellite systems due to the distance amongst platforms being much larger than the carrier wavelength. Grating lobes create harmful intra-beam interference. A logarithmic spiral array (LSA) flying formation for the swarm provides grating-lobe mitigation solutions by breaking the regularity of conventional uniform arrays. However, this grating-lobe mitigation is less effective when the number of swarms is reduced for near-term feasibility.

Prior art satellite (and necessarily the antenna in the satellite) appears stationary in orbit due to its high altitude, so the beam coverage area was pretty static. Here, there is a dynamic moving of the beam in shape, size and location because the satellite appears moving. LEO orbit results in lower latency but also in a dynamically changing overlap of beam footprints. Moreover, the large distances between the satellite and devices require a high transmission power to provide connectivity via Orthogonal Frequency-Division Multiplexing (OFDM) transmission. Prior art does not consider OFDM; however, D2D propagation can suffer from a non-line-of-sight (NLOS) condition with multipath that is best combatted by OFDM. In addition, OFDM benefits D2D connectivity by providing smoother integration and better compatibility with terrestrial networks as OFDM is specified in their 5G New Radio (NR) air interface. Lastly, the prior art uses a Uniform Rectangular Array formation that creates severe grating lobes because distances between some of radiating elements is greater than 20 times the carrier wavelength.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Advantages of using cooperative satellite swarms for achieving D2D connectivity include lower cost associated with the production and launch of small satellites. Another is fault tolerance as the task is distributed among multiple satellites ensuring mission survivability when individual platforms fail. Scalability is yet another advantage as more swarm members can be launched over time to further add more radiating elements to the overall array. Finally, satellite swarms are capable of providing highly directive beams with very narrow beamwidth, taking full advantage of the spatial multiplexing gain of massive MIMO technology.

The present teachings disclose a satellite system including a transmitter and receiver for use in the frequency domain. The system uses OFDM for communicating between the satellite and devices. OFDM is a multi-carrier modulation technique that divides a wide bandwidth into multiple, closely spaced, narrowband subchannels, allowing for efficient data transmission, particularly in wireless communication systems such as Wi-Fi and 4G/5G.

The satellite swarm includes a regenerative payload that works with a beamforming antenna to transmit a beamforming precoded signal. In some embodiments, the satellite transmitter maximizes a Signal to Noise Ratio (SNR) of the transmitted without consideration of interference elimination, mitigation or reduction.

In some aspects, the techniques described herein relate to a method for mitigating intra-beam interference, the method including: receiving a desired beam and interfering beams transmitted by a satellite swarm; dividing the interfering beams into an intense set, a strong set, and a noise-floor set based on intensity of the interfering beams to mitigate intra-beam interference; decoding symbols from the strong set into a subtractive-cancellation set and the intense set into an optimal-Bayesian set; subtracting symbols of the subtractive-cancellation set; and addressing symbols of the optimal-Bayesian set in an optimal-Bayesian fashion, wherein the desired beam and the interfering beams include an Orthogonal Frequency-Division Multiplexing (OFDM) transmission precoded with beamforming weights.

In some aspects, the techniques described herein relate to a method for mitigating intra-beam interference wherein the beamforming weights include a matrix W=[w₁, w₂, . . . , w_{N}_{ᵤ}]∈ [symbol] representing Nᵤ beams, each feeding radiating elements of the satellite swarm (NₛNₑ), the matrix W includes vectors wᵢ∈ [symbol] , each of the vectors includes a complex-valued weight vector

$$\underline{{w}_{i}} = {[ {( {w}_{i}^{( 1 )} )}^{T} , {( {w}_{i}^{( 2 )} )}^{T} , … , {( {w}_{i}^{( {N}_{s} )} )}^{T} ]}^{T} ∈ {ℂ}^{( {N}_{s} {N}_{e} ) \times 1} ,$$

where

$${\underline{w}}_{i}^{( s )} = ∈ {ℂ}^{{N}_{e} \times 1}$$

for a respective satellite of the Nₛ satellites.

In some aspects, the techniques described herein relate to a method for mitigating intra-beam interference wherein the matrix W is based on criteria including one or more of maximum-ratio transmission (MRT), zero-forcing (ZF), regularized ZF (RZF), minimum mean-square error (MMSE), maximum signal-to-leakage-and-noise-ratio (SLNR), or a combination thereof.

In some aspects, the techniques described herein relate to a method for mitigating intra-beam interference wherein the intense set includes the interfering beams with highest intensity among the interfering beams, wherein the strong set includes the interfering beams with intermediate intensity among the interfering beams, and wherein the noise-floor set includes the interfering beams with lowest intensity among the interfering beams.

In some aspects, the techniques described herein relate to a method for mitigating intra-beam interference wherein the subtractive-cancellation set includes strong interferer sources and the optimal-Bayesian set includes intense interferer sources.

In some aspects, the techniques described herein relate to a method for mitigating intra-beam interference wherein elements of the noise-floor set are incorporated through their powers, elements of the subtractive-cancellation set are incorporated via first-order and second-order moments computed from a priori probabilities, and the optimal-Bayesian set uses a priori probability mass function of interfering symbols.

In some aspects, the techniques described herein relate to a method for mitigating intra-beam interference including using a modular structure to mitigate interference terms with computational power commensurate with a level of interference experienced, with a strength of a transmitted modulation/coding format, or a combination thereof.

In some aspects, the techniques described herein relate to a method for mitigating intra-beam interference including using a soft-in soft-out successive interference cancellation structure for joint detection and forward-error correction decoding in an iterative fashion to recover information bits.

In some aspects, the techniques described herein relate to a method for mitigating intra-beam interference wherein the receiving is performed by a low-power omnidirectional antenna, and the beams include an S-band carrier.

In some aspects, the techniques described herein relate to a method for mitigating intra-beam interference wherein the satellite swarm includes radiating elements distributed across a plurality of satellites disposed in a logarithmic spiral array (LSA) in a low Earth orbit, and the radiating elements of the satellite swarm operate as a distributed array.

In some aspects, the techniques described herein relate to a system to mitigate intra-beam interference, the system including: an antenna configured to receive a desired beam and interfering beams transmitted by a satellite swarm; and a processor. The processor is configured to: divide the interfering beams into an intense set, a strong set, and a noise-floor set based on intensity of the interfering beams to mitigate intra-beam interference, decode symbols from the strong set into a subtractive-cancellation set and the intense set into an optimal-Bayesian set, subtract symbols of the subtractive-cancellation set, and address symbols of the optimal-Bayesian set in an optimal-Bayesian fashion. In the system, the desired beam and the interfering beams include an Orthogonal Frequency-Division Multiplexing (OFDM) transmission precoded with beamforming weights.

In some aspects, the techniques described herein relate to a system to mitigate intra-beam interference wherein the beamforming weights include a matrix W=[w₁, w₂, . . . , w_{N}_{ᵤ}]∈ [symbol] representing Nᵤ beams, each feeding radiating elements of the satellite swarm (NₛNₑ), the matrix W includes vectors wᵢ∈ [symbol] , each of the vectors includes a complex-valued weight vector

$$\underline{{w}_{i}} = {[ {( {w}_{i}^{( 1 )} )}^{T} , {( {w}_{i}^{( 2 )} )}^{T} , … , {( {w}_{i}^{( {N}_{s} )} )}^{T} ]}^{T} ∈ {ℂ}^{( {N}_{s} {N}_{e} ) \times 1} ,$$

where

$${\underline{w}}_{i}^{( s )} = ∈ {ℂ}^{{N}_{e} \times 1}$$

for a respective satellite of the Nₛ satellites.

In some aspects, the techniques described herein relate to a system to mitigate intra-beam interference wherein the matrix W is based on criteria including one or more of maximum-ratio transmission (MRT), zero-forcing (ZF), regularized ZF (RZF), minimum mean-square error (MMSE), maximum signal-to-leakage-and-noise-ratio (SLNR), or a combination thereof.

In some aspects, the techniques described herein relate to a system to mitigate intra-beam interference wherein the intense set includes the interfering beams with highest intensity among the interfering beams, wherein the strong set includes the interfering beams with intermediate intensity among the interfering beams, and wherein the noise-floor set includes interfering beams with lowest intensity among the interfering beams.

In some aspects, the techniques described herein relate to a system to mitigate intra-beam interference wherein the subtractive-cancellation set includes strong interferer sources and the optimal-Bayesian set includes intense interferer sources.

In some aspects, the techniques described herein relate to a system to mitigate intra-beam interference wherein elements of the noise-floor set are incorporated through their powers, elements of the subtractive-cancellation set are incorporated via first-order and second-order moments computed from a priori probabilities, and the optimal-Bayesian set uses a priori probability mass function of interfering symbols.

In some aspects, the techniques described herein relate to a system to mitigate intra-beam interference wherein the processor is further configured to use a modular structure to mitigate interference terms with computational power commensurate with a level of interference experienced, with a strength of a transmitted modulation/coding format, or a combination thereof.

In some aspects, the techniques described herein relate to a system to mitigate intra-beam interference wherein the processor is further configured to use a soft-in soft-out successive interference cancellation structure for joint detection and forward-error correction decoding in an iterative fashion to recover information bits.

In some aspects, the techniques described herein relate to a system to mitigate intra-beam interference wherein the antenna is a low-power omnidirectional antenna, and the desired beam and the interfering beams include an S-band carrier.

In some aspects, the techniques described herein relate to a system to mitigate intra-beam interference wherein the satellite swarm includes radiating elements distributed across a plurality of satellites disposed in a logarithmic spiral array (LSA) in a low Earth orbit, and the radiating elements of the satellite swarm operate as a distributed array.

Additional features will be set forth in the description that follows, and in part will be apparent from the description, or may be learned by practice of what is described.

### BRIEF DESCRIPTION OF DRAWINGS

In order to describe the manner in which the above-recited and other advantages and features may be obtained, a more particular description is provided below and will be rendered by reference to specific embodiments thereof which are illustrated in the appended drawings. Understanding that these drawings depict only typical embodiments and are not, therefore, to be limiting of its scope, implementations will be described and explained with additional specificity and detail with the accompanying drawings.

FIG. 1 illustrates a satellite swarm system for direct-to-device connectivity according to various embodiments.

FIG. 1A is a logical illustration of a distributed swarm of nine satellites, each with a uniform planar array, disposed/flying in conformance to an LSA geometry, according to various embodiments.

FIG. 2 illustrates equations used in the present teachings according to various embodiments.

FIG. 3 illustrates an onboard processor of a satellite of a satellite swarm implementing a Nᵤ beamforming network hosted by a sth satellite, according to various embodiments.

FIG. 4 illustrates a receiver when two dominant interferers are present according to various embodiments.

FIG. 5A illustrates a test case of device distribution in a service area, shown in the satellite UV-coordinate system, with maximum scan angle of ±25° for a LEO satellite swarm, according to various embodiments.

FIG. 5B illustrates a zoomed-in view around the worst-affected device of FIG. 5A.

FIG. 6A illustrates an SIR profile experienced by the worst-affected device 506′ of FIG. 5B.

FIG. 6B illustrates throughput calculations for all devices 506 of FIG. 5A.

FIG. 7A illustrates radiation patterns, against the azimuth angle, of a desired beam (the worst-affected device 506′ of FIG. 5B) and three strongest interfering beams (beams for devices 506″, 506″′) associated with the worst-affected device 506′.

FIG. 7B illustrates radiation patterns, against the elevation angle, of a desired beam (the worst-affected device of FIG. 5B) and three strongest interfering beams (beams for devices 506″, 506″′) associated with the worst-affected device 506′.

FIG. 8 illustrates Packet Error Rate (PER) results for a receiver with a spatial profile of the intra-beam interference experienced by a satellite swarm configuration according to various embodiments.

FIG. 9 illustrates a method for beamforming according to various embodiments.

FIG. 10 illustrates a method for mitigating intra-beam interference according to various embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Embodiments are discussed in detail below. While specific implementations are discussed, this is done for illustration purposes only. A person skilled in the relevant art will recognize that other components and configurations may be used without parting from the spirit and scope of the subject matter of this disclosure.

The terminology used herein is for describing embodiments only and is not intended to be limiting of the present disclosure. As used herein, the singular forms “a,” “an” and “the” are intended to include the plural forms as well, unless the context clearly indicates otherwise. Furthermore, the use of the terms “a,” “an,” etc. does not denote a limitation of quantity but rather denotes the presence of at least one of the referenced items. The use of the terms “first,” “second,” and the like does not imply any order, but they are included to either identify individual elements or to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

The present teachings provide effective compensation of intra-beam interference for satellites that are centralized or distributed in a swarm. The interference may be particularly pronounced when utilizing full frequency reuse in high-throughput systems.

The present teachings may be applied in the ground segment. In some embodiments, a ground segment can reduce harmful effects of intra-beam interference, generated by full frequency reuse as well as grating lobes in distributed satellite swarms. A ground segment application may tackle the intra-beam interference from the grating lobes for a satellite swarm that remain even for a nonuniform LSA swarm formation in space.

In some embodiments, a receiver of the present teachings may be based on a modular structure that can mitigate interference terms with computational power commensurate with a level of interference experienced at the UE or on a strength of a transmitted modulation/coding format. The present teachings include a divide-and-conquer (DAC) strategy that decomposes interfering sources into smaller sets per their intensity. Weak interfering sources are not decoded and form a set of sources that is considered thermal noise. The remaining sources are decoded and are split into a set into strong interfering sources and intense interfering sources. The strong interfering sources are for subtraction and the intense interferers are addressed in an optimal-Bayesian fashion. The receiver implements fast-Fourier transform (FFT) for processing a received signal into the frequency domain.

In some embodiments, a receiver of the present teachings may complement transmitter-based techniques applied on the ground segment or onboard satellites that use beamforming/precoding to optimize the focusing and aiming of beams towards UEs.

### Satellite System Model

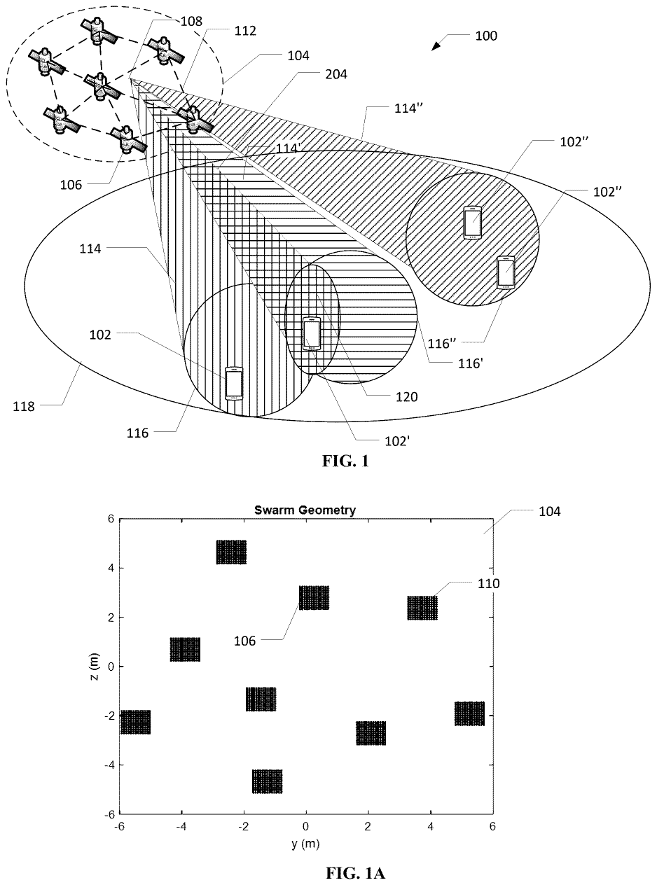

FIG. 1 illustrates a satellite swarm system for direct-to-device connectivity according to various embodiments.

FIG. 1A is a logical illustration of a distributed swarm of nine satellites, each with a uniform planar array, disposed/flying in conformance to an LSA geometry, according to various embodiments.

A satellite swarm system 100 may establish connectivity with terrestrial devices 102, 102′, 102″ such as cellular smartphones or tablets in a coverage area 118. A swarm 104 may include satellites 106 that collaborate to create a distributed array 108, a massive distributed array with a large virtual aperture. The distributed array 108 may collectively include a large number of directly radiating elements 110 (see FIG. 1A). Through collaboration, the distributed array 108 formed by radiating elements 110 of satellite swarm 104 realizes joint transmission as a massive multi-input multi-output (MIMO) architecture in space. Each of the satellites 106 may be a small and lightweight satellite that is used to host onboard a subset of the radiating elements 110. Inter-satellite links (ISLs) 112 between satellites 106 are used for synchronization, facilitating cooperation.

The distributed array 108 overall forms a phased antenna array. Distributed array 108 may generate multiple simultaneous or joint beams 114, 114′, 114″ steered toward different beam areas 116, 116′, 116″. An overall beam pattern may simultaneously or jointly realize beams targeting beam areas of active devices, for example, here beams 114, 114′, 114″ targeting beam areas 116, 116′, 116″. Each of the beams 114, 114′, 114″ may utilize full frequency reuse; the frequency band and polarization of the beams 114, 114′, 114″ are the same. In the example of FIG. 1, device 102′ may be served by beam 114′. Device 102′ suffers from intra-beam interference 120 that is very strong between beams 114, 114′ due to their side lobes and/or grating lobes. Device 102′ suffers from intra-beam interference that is weaker between beams 114′, 114″ due to their side lobes and/or grating lobes. The intra-beam interferences can severely degrade performance of device 102′ if left unmitigated.

For the space segment, consider Nₛ satellite platforms, each with Nₑ radiating elements, with a total of (NₛNₑ) active antenna elements with positions

$${p}_{n}^{( s )} ∈ {ℝ}^{3} for n = 1 , … , {N}_{e}$$

and s=1, . . . , Nₛ. The swarm flying formation of Nₛ small satellites may follow a uniform or nonuniform geometry with separation much larger than λ where λ is the carrier wavelength.

An exemplary distributed array 108 is shown in FIG. 1A formed by Nₛ satellites of a swarm, for example, Nₛ=9 satellites. Each of the swarm satellites hosts radiating elements 110 disposed in a planar subarray, for example, a square planar subarray. In some embodiments, the square planar subarray may include 13×13 radiating elements 110. The radiating elements 110 may be disposed with uniform inter-element spacing of about λ/2 in the planar subarray. In an exemplary embodiment of Nₛ of 9 satellites, each hosting 13×13 radiating elements, a distributed array having a total of 1521 radiating elements can be formed. In some embodiments, the swarm may be organized in a nonuniform pattern that forms a logarithmic spiral array (LSA). An LSA formation for the swarm may suppress grating lobes formed due to large separations between satellites within a swarm.

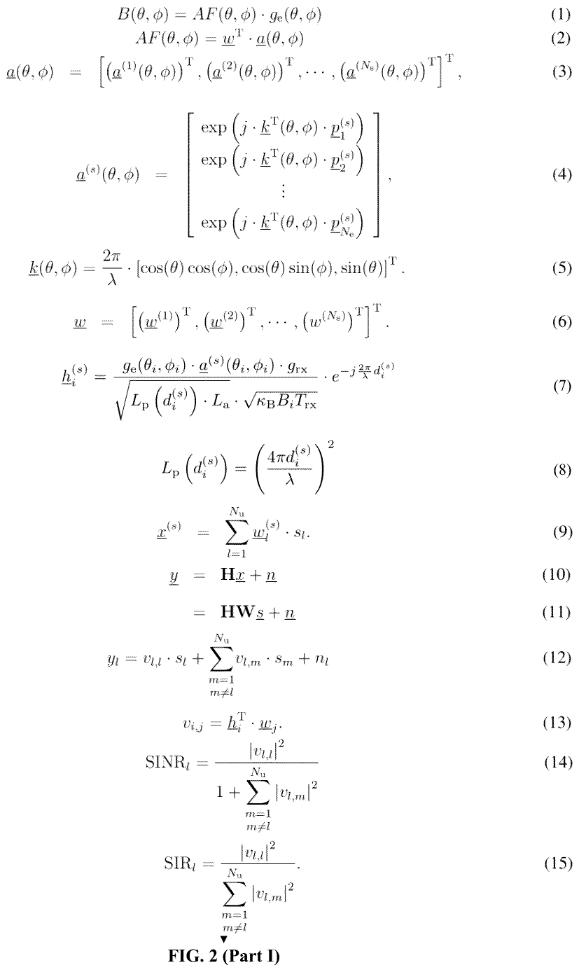

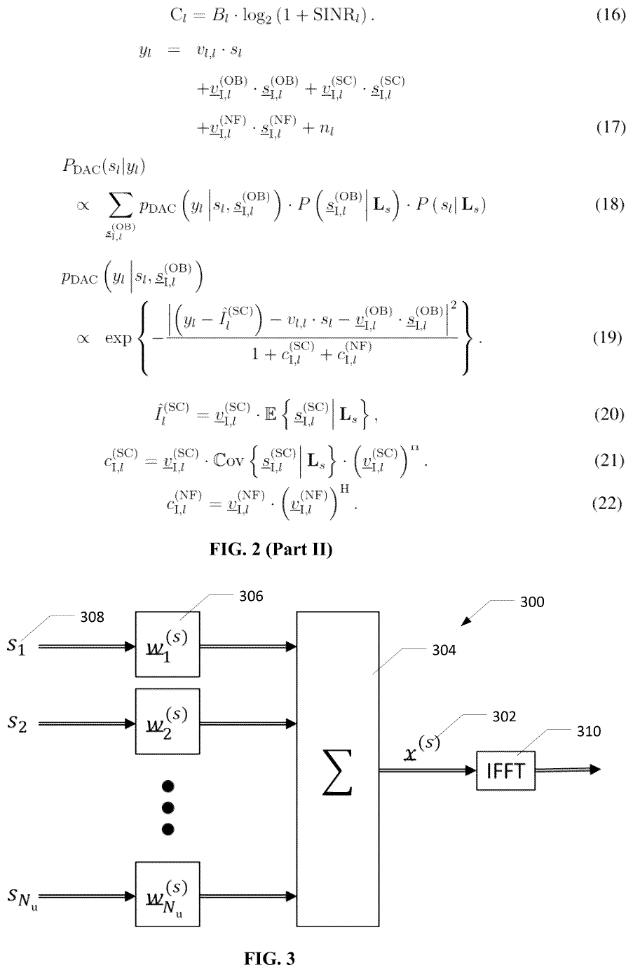

FIG. 2 illustrates equations used in the present teachings according to various embodiments.

FIG. 3 illustrates an onboard processor of a satellite of a satellite swarm implementing a Nᵤ beamforming network hosted by a sth satellite, according to various embodiments.

An onboard processor 300 of a satellite of a swarm may radiate a beam pattern 302 (x^{(s)}) by a portion of a distributed array 304 when steered to a general location. The beam pattern 302 (x^{(s)}) may be represented by an elevation/azimuth angle pair (θ, φ) mathematically described as Eq. (1), where gₑ(θ, φ) is the pattern of a single element, assumed common among the satellites for ease of expression. The AF(θ, φ) in Eq. (1) is the array factor and is expressed as Eq. (2), where a(θ, φ)∈ [symbol] is the overall steering vector composed of those vectors pertaining to individual satellites as Eq. (3) and Eq. (4). In Eq. (4) k(θ, φ)∈ [symbol] is the wave vector that describes the phase variation of the far-field plane wave propagation as Eq. (5). In Eq. (2), w∈ [symbol] is the excitation vector designed to focus and aim the commanded beam, composed of those vectors pertaining to individual sth satellites and precoded with weights 306, w^{(s)}∈ [symbol] , appearing in Eq. (6).

For the ground segment, consider a service area corresponding to a minimum elevation angle that is subdivided into a fixed-grid lattice with radius based on the average half-power beamwidth (HPBW). A very large number of devices is distributed in the service area. A device is assigned to the beam whose center is nearest to its position. Multiple concurrent devices served by the same beam equally share the available resources in time or frequency. A generic ith device on the ground, identified by (θᵢ, φᵢ) (for example, a smartphone), with a single omnidirectional antenna of gain gᵣₓ that is typically equal to 0 dBi. For each time slot, a scheduling function provides a subset of devices to be served by Nᵤ device beams.

For the signal transmission band, an OFDM system is assumed with N_{c} subcarriers. OFDM is adopted to combat frequency-selective inter-symbol interference (ISI) by converting a broadband frequency-selective multipath fading channel into a number of narrowband flat-fading channels, for example, in Wi-Fi and 4G/5G implementations. This is implemented via the application of an inverse fast Fourier transform (IFFT) 310 at the transmitter (here in the onboard processor 300) and a fast Fourier transform (FFT) (for example, FFT 403 in FIG. 3) at the receiver.

### Mathematical Model at the Receiver

To introduce a mathematical model for the received signals, let s=[s₁, s₂, . . . , s_{N}_{ᵤ}]^{T}∈ [symbol] be the complex-valued vector of unit-variance user symbols transmitted over a specific OFDM subcarrier, and x=[x⁽¹⁾)^{T}, (x⁽²⁾)^{T}, . . . , (x^{(N}^{ₛ}⁾)^{T}]∈ [symbol] be the overall signal vector emitted by the radiating elements hosted onboard individual sth satellites, x^{(s)}∈ [symbol] , before conversion to the time-domain using IFFT blocks. Also, let y=[y₁, y₂, . . . , y_{N}_{ᵤ}]∈ [symbol] be the vector of received frequency-domain symbols after the application of FFT blocks. Define H=[h₁, h₂, . . . , h_{N}_{ᵤ}]^{T}∈ [symbol] as the channel matrix collecting across user beams where

$$\underline{{h}_{i}} = {[ {( {\underline{h}}_{i}^{( 1 )} )}^{T} , {( {\underline{h}}_{i}^{( 2 )} )}^{T} , … , {( {\underline{h}}_{i}^{( {N}_{s} )} )}^{T} ]}^{T} ∈ {ℂ}^{( {N}_{s} {N}_{e} ) \times 1} ,$$

represents the channel coefficient vector between the overall (NₛNₑ) radiating elements and the ith device. The individual block pertaining to the sth satellite within the swarm

$$( {\underline{h}}_{i}^{( s )} ) ∈ {ℂ}^{{N}_{e} \times 1}$$

in hᵢ is computed as Eq. (7). In Eq. (7), a^{(s)} (θᵢ, φᵢ) is the steering vector towards the ith device from Eq. (4),

$${d}_{i}^{( s )}$$

is the slant range between the ith device and the sth satellite,

$${L}_{p} ( {d}_{i}^{( s )} )$$

is the free-space path loss given by Eq. (8), and Lₐ denotes additional losses from other impairments such as the atmosphere, shadowing and polarization, etc. The channel coefficient vector in Eq. (7) is normalized by the noise power where κ_{B} is the Boltzmann constant, Tᵣₓ is the device receiver noise temperature and Bᵢ is the ith device bandwidth.

The onboard beamforming/precoding is described by matrix W=[w₁, w₂, . . . , w_{N}_{ᵤ}]∈ [symbol] representing Nᵤ simultaneous beams, each feeding the overall swarm radiating elements, (NₛNₑ). The vector wᵢ∈ [symbol] in the matrix W is further decomposed into

$$\underline{{w}_{i}} = {[ {( {\underline{w}}_{i}^{( 1 )} )}^{T} , {( {\underline{w}}_{i}^{( 2 )} )}^{T} , … , {( {\underline{w}}_{i}^{( {N}_{s} )} )}^{T} ]}^{T} ∈ {ℂ}^{( {N}_{s} {N}_{e} ) \times 1} ,$$

where

$${\underline{w}}_{l}^{( s )} ∈ {ℂ}^{{N}_{e} \times 1}$$

is the complex-valued weight vector implemented onboard an individual sth satellite.

One exemplary implementation of an onboard processor within the payload of the sth satellite is displayed in FIG. 3, implementing Eq. (9). Onboard processor 300 includes multiple beamforming networks, one for each of the simultaneous Nᵤ device signals. After frequency conversion and amplification, each active antenna element is then fed a linear combination of the device signals with complex-valued weights extracted from

$${\underline{w}}_{l}^{( s )} ∈ {ℂ}^{{N}_{e} \times 1} .$$

The output is then processed by an IFFT block to transform the precoded symbols into the time domain. The beamforming/precoding matrix W can be based on several criteria that include maximum-ratio transmission (MRT), referred to as conjugate-matching or matched-filtering (MF), zero-forcing (ZF), regularized ZF (RZF), minimum mean-square error (MMSE), maximum signal-to-leakage-and-noise-ratio (SLNR) among others.

The received signal vector can then be expressed as Eq. (10) and Eq. (11). In Eq. (10) and Eq. (11), n∈ [symbol] is a vector of additive white Gaussian noise (AWGN) samples with zero mean and unit variance.

In some embodiments, the above-described mathematical model illustrating a distributed satellite system is applicable to a centralized satellite system by using Nₛ=1 and hosting the overall number of radiating elements.

### Receiver Architecture

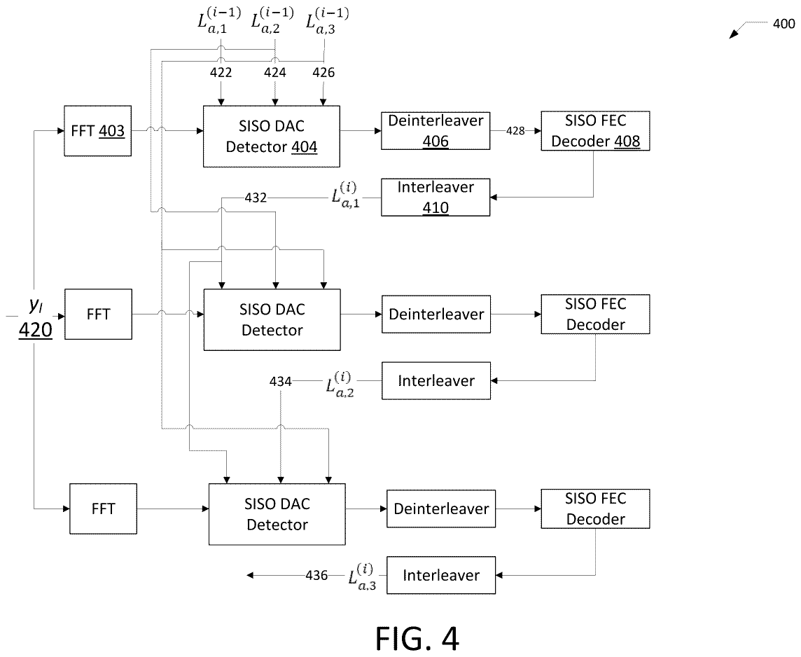

FIG. 4 illustrates a receiver when two dominant interferers are present according to various embodiments.

A receiver 400 may implement a soft-in soft-out (SISO) divide-and-conquer (DAC) strategy that decomposes the interfering symbols into smaller sets depending on their intensity. Receiver 400 may be a low-complexity advanced receiver suitable for D2D devices. A first or noise-floor (NF) set is created from the weak interfering sources that are not decoded but considered as thermal noise. The interfering symbols of remaining sources are decoded and then split into a second or subtractive-cancellation (SC) set including strong interferer sources and a third or optimal-Bayesian (OB) set including intense interferer sources. The receiver subtracts the sources of the SC set and addresses the sources of the intense interferer set in an optimal-Bayesian (OB) fashion.

In some embodiments, the elements of the NF set are incorporated in the SISO DAC detector only through their powers; elements of the SC set are incorporated via first-order and second-order moments, computed from a priori probabilities 422, 424, 426; while the OB set uses the a priori probability mass function (pmf) of the interfering symbols from within the OB set. As such, the receiver 400 uses a modular structure. With the modular structure, interference terms may be mitigated with computational power commensurate with either the level of interference experienced at the device or on the strength of the transmitted modulation/coding format.

A logical diagram of the receiver 400 is illustrated in FIG. 4. Receiver 400 uses a SISO successive interference cancellation (SIC) structure—SISO DAC Detector 404, Deinterleaver 406 and SISO FEC decoder jointly—wherein joint detection and forward-error correction (FEC) decoding are applied in an iterative fashion to recover the information bits intended for a device. Receiver 400 may be considered an outer ith iteration of a receiver implementation.

The receiver 400 begins by processing the most robust signal in the advanced receiver detector while assuming equally likely a priori information for all the interfering signals being decoded jointly. In some embodiments, a signal having a maximum SNR or one that is most heavily FEC-encoded from the received signals is used as the most robust signal. The DAC strategy, detailed below, provides the symbol a posteriori probabilities (APPs) 432, 434, 436 which are passed to the FEC decoders 408 as bit-wise log-likelihood ratios (LLRs), after demapping and deinterleaving. The FEC decoder 408 subsequently generates bit-wise LLRs that are converted to extrinsic information about the symbols. The receiver 400 uses, usually immediately, this extrinsic information as a priori for processing the lesser robust signals, thereby incorporating the latest information from the FEC decoding, during the same outer iteration, leading to faster convergence. At the completion of an outer iteration, the receiver has a priori information for all the co-channel signals being jointly processed and can use the a priori information during the next outer iteration. In FIG. 4, the implementation of fast-Fourier transform (FFT) 403 is at the receiver 400 is for processing a received signal 420 into the frequency domain.

From Eq. (11) it follows that the received signal 420 by the/th device is given as Eq. (12), where Eq. 12 depends on Eq. (13). The first term in Eq. (12) is the desired signal and the second term represents the intra-beam interference. To provide key performance indicators (KPIs), a signal-to-interference-and-noise ratio (SINR) at the ith device is defined as Eq. (14). The signal-to-interference ratio (SIR) is defined as Eq. (15). From Eq. (14), the capacity or throughput, in bits per second (bps), for the lth device is computed based on Shannon formula as Eq. (16).

For the DAC strategy, yᵢ of Eq. (12) is equivalently given according to Eq. (17), where the elements of {sₘ; m=1, . . . , Nᵤ; m≠l} are split into three sets,

$${\underline{s}}_{I , l}^{( NF )} , {\underline{s}}_{I , l}^{( SC )} , {\underline{s}}_{I , l}^{( OB )} ,$$

and the row-vectors

$${\underline{v}}_{I , l}^{( NF )} , {\underline{v}}_{I , l}^{( SC )} , {\underline{v}}_{I , l}^{( OB )}$$

are their corresponding spatial coefficients associated with channel and beamforming vectors in Eq. (13). Eq. (17) clarifies that the advanced receiver has the capability to complement transmitter-based techniques applied on the ground segment or onboard satellites that use beamforming/precoding matrix W to optimize the focusing and aiming of beams towards devices.

Based on Eq. (17), the SISO DAC detector provides P_{DAC}(sₗ|yₗ) mathematically expressed as Eq. (18) where p_{DAC}(·) is the likelihood function associated with yₗ, conditioned on the desired and interfering symbols from the OB set. It assumes that yₗ is a random variable that retains a Gaussian probability density function (pdf) or Eq. (19).

In Eq. (19), the soft estimate of interference from the co-channel beams arising from the SC set,

$${\hat{I}}_{l}^{( SC )} ,$$

is subtracted after computing it as Eq. (20). In Eq. (20), the variance contribution

$${c}_{I , l}^{( SC )}$$

is expressed as Eq. (21). The expressions

$$𝔼 \{ {\underline{s}}_{I , l}^{( SC )} \vert {L}_{s} \} and {ℂ}_{OV} \{ {\underline{s}}_{I , l}^{( SC )} \vert {L}_{s} \}$$

in Eq. (20) and Eq. (21) are obtained from component-wise first-order and second-order moment relations using the symbol probabilities from the individual FEC decoders.

In Eq. (21),

$${c}_{I , l}^{( SC )}$$

can be implemented via a single summation as the matrix

$$ℂ ov \{ {\underline{s}}_{I , l}^{( SC )} \vert {L}_{s} \}$$

is diagonal due to the independence assumption justified by the interleaving. Finally, the variance contribution from the NF set,

$${c}_{I , l}^{( N F )}$$

in Eq. (19), is computed based on the channel and beamforming coefficients, without requiring decoding, due to Eq. (22).

The APPs evaluated by the SISO DAC detector, expressed in Eqs. (18)-(22), are iteratively exchanged with soft-output FEC decoders utilizing the SIC structure, outlined in FIG. 4, where the intra-beam signals are detected and decoded serially, adopting the order from most robust to least robust signal.

### Numerical Studies

A representative distributed satellite system illustrates the effectiveness of the receiver's capabilities in suppressing intra-beam interference. The study assumes the swarm flies at an orbital altitude of 500 km, uses an S-band carrier frequency of 2 GHz (or carrier wavelength of 15 cm), and utilizes a downlink bandwidth of 30 MHz. In the study, there are nine satellites in the swarm arranged to form an LSA, with inter-satellite spacing as shown in FIG. 1A. Each satellite hosts a square planar array with 13×13 radiating elements with inter-element spacing of half a carrier wavelength, or 7.5 cm. There is a total of 1521 radiating elements in the overall swarm array. The individual radiating elements emit at a power level of 0.35 W with a gain of 4.87 dBi and element patterns that follow the 3GPP standard as specified in TR 38.901. The terrestrial device employs an omnidirectional antenna with a gain of 0 dBi and a receiver with noise temperature of 2013.6° K, corresponding to a noise figure of 9 dB and a reference noise temperature of 290° K. The study allows for an additional 3 dB of losses to account for impairments such as atmospheric, shadowing, polarization, and the like.

Furthermore, the simulations implement an OFDM system with subcarrier spacing (SCS) of 15 kHz, employing IFFT and FFT blocks at the transmitters and receivers, respectively, with N_{c} of 2048 subcarriers.

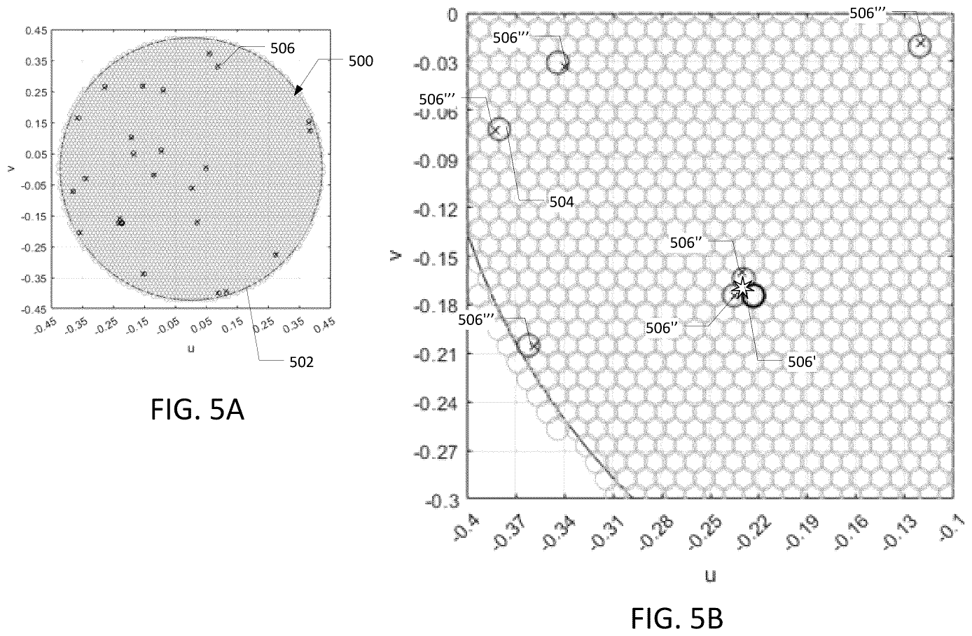

FIG. 5A illustrates a test case of device distribution in a service area, shown in the satellite UV-coordinate system, with maximum scan angle of ±25° for the LEO satellite swarm of the study, according to various embodiments.

FIG. 5A displays a service area 500 when a satellite swarm (not shown) is employed with a maximum scan angle of ±25°, corresponding to a service area 502 in the satellite UV-coordinate system. The service area 502 is divided into fixed-grid beam footprints 504 with a radius that matches the beam HPBW of 0.78° as obtained by the satellite swarm. The study uses a test case of device distribution with 25 active devices 506 in service area 502; in FIG. 5A the devices are marked by an ‘x’. The satellite swarm may generate multiple simultaneous beams towards beam footprints with active devices while utilizing full frequency reuse. For this test case of device distribution, the swarm satellites are providing 25 simultaneous beams, serving active devices 506 individually. Generally, active devices 506 served by the same beam equally share the available resources in time or frequency.

FIG. 5B illustrates a zoomed-in view around the worst-affected device of FIG. 5A.

FIG. 5B provides a zoomed-in view of FIG. 5A around active device 506′ suffering from the lowest SIR. Active device 506′ is plagued by intra-beam interference from two adjacent dominant beams serving active devices 506″ that heavily degrade performance of active device 506′. Active device 506′ also suffers from intra-beam interference from other neighboring beams serving active devices 506″′.

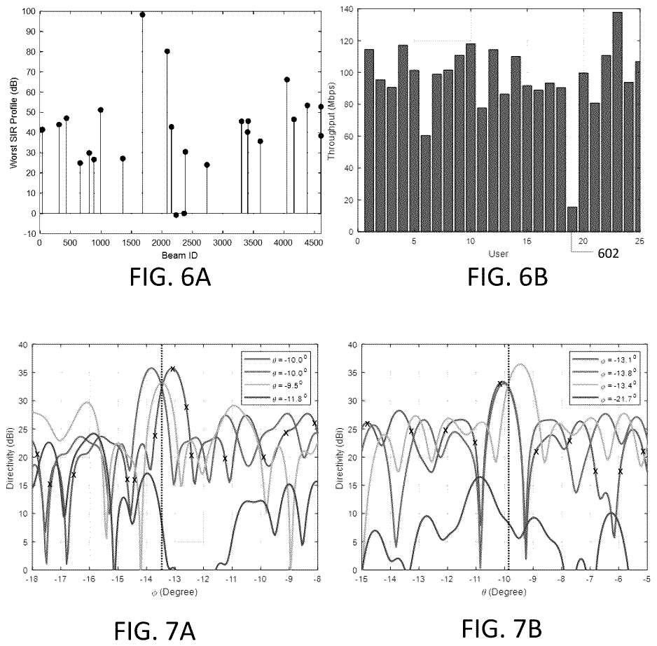

FIG. 6A illustrates an SIR profile experienced by the worst-affected device 506′ of FIG. 5B. FIG. 6B illustrates throughput calculations for all devices 506 of FIG. 5A.

FIG. 6A plots the SIR calculations, using Eq. (15), for the active device 506′, showing 24 interfering active beams with two interferers around 0 dB along with others that are at least 24 dB. The throughput calculations, using Eq. (16), for all active devices 506 are shown in FIG. 6B, showing the worst-affected active device (active device 506′) to be at 15.4 Mbps, which is much lower than the throughput enjoyed by other active devices 506 of at least 60 Mbps. FIG. 6B indicates that an advanced receiver is required to tackle the very challenging intra-beam environment experienced by some active devices, including throughput 602 in Mbps experienced by the worst-affected device 506′ of FIG. 5B.

FIG. 7A illustrates radiation patterns, against the azimuth angle, of a desired beam (the worst-affected device 506′ of FIG. 5B) and three strongest interfering beams (beams for devices 506″, 506″′) associated with the worst-affected device 506′.

FIG. 7B illustrates radiation patterns, against the elevation angle, of a desired beam (the worst-affected device of FIG. 5B) and three strongest interfering beams (beams for devices 506″, 506′″) associated with the worst-affected device 506′.

FIG. 7A shows the radiation patterns, against the azimuth angle, of a desired beam for the worst-affected device (marked by ‘x’) and three strongest interfering active beams, all directed toward their respective beam footprint centers. The device location, marked by the dotted vertical line, is away from a beam footprint center. The beam patterns are calculated based on equations (1)-(8) using the MRT, or matched-filtering (MF), criteria.

FIG. 7B is its elevation-angle counterpart. FIG. 7A and FIG. 7B illustrate that at the device location, the desired beam is at the same strength, about 0 dB, as two dominant interfering beams and about 24 dB better than the third one.

End-to-end physical-layer simulations were conducted that employ modulation/coding (MOD-COD) choices defined in the 3rd Generation Partnership Project (3GPP) standard on New Radio (NR) for the Fifth-Generation (5G) of wireless terrestrial networks, including low-density parity check (LDPC) forward-error correction (FEC) coding. The modulation uses Amplitude-Phase Shift Keying (APSK) constellations, and the codewords consists of 5760 bits. The spatial profile of the intra-beam interference is derived from FIG. 6A when full-frequency reuse is utilized. In this embodiment, SISO DAC detectors jointly process three dominant signals as follows. A first of the more robust interferers is included in the SC set while the other dominant interferer is included in the OB set. The weaker interfering beams are included in the NF set. The soft outputs of the DAC detectors, as described above, are iteratively exchanged with the soft outputs of individual FEC decoders, utilizing the SIC structure of FIG. 4.

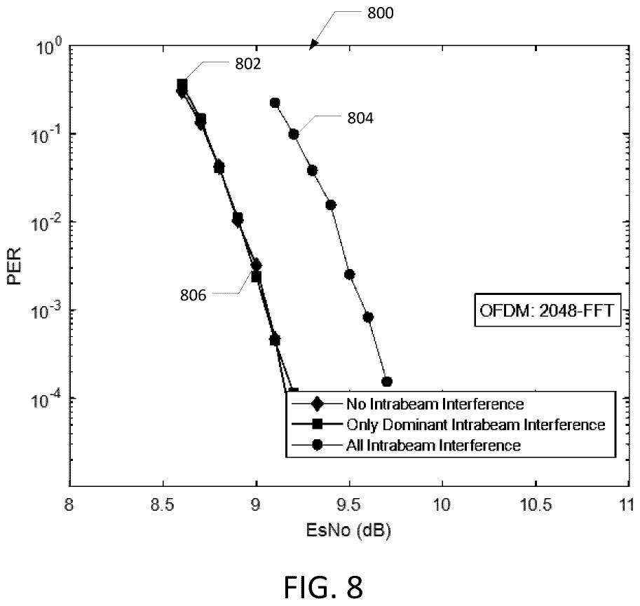

FIG. 8 illustrates Packet Error Rate (PER) results for a receiver with a spatial profile of the intra-beam interference experienced by a satellite swarm configuration according to various embodiments.

FIG. 8 illustrates a chart 800 of packet error rates (PERs) when using 16APSK with LDPC encoding of rate 2/3 for a worst-affected device, while two dominant intra-beam interferers use QPSK with rates of 2/5 and 1/5, respectively. These encodings correspond to an information rate triple of (2.67, 0.80, 0.40), in bits per symbol, for the desired beam and the two dominant interfering beams. The chart 800 of PER results in FIG. 8 indicates that the 16APSK MODCOD performance gap between a PER 802 of a single-device AWGN channel and a PER 806 of an AWGN channel with the weaker intra-beam interferers is approximately 0.55 dB, at PER of 10⁻³. This is close to the receiver noise-floor contribution of the weaker intra-beam interfering signals at that Eₛ/N₀ range. Furthermore, as is evident in FIG. 8, the advanced receiver can completely mitigate an impact of two dominant intra-beam interferers, signified by the closeness of PER 802 and PER 806. Also, the PER 804 approaches single-device performance but with a gap consistent with weak residual intra-beam interference. In some embodiments, the information-theoretic achievable-rate triple, using principles of network information theory, for this SIR profile and AWGN level is (2.93, 0.88, 0.54), in bits per symbol, using constrained-capacity calculations with infinitely long codewords. A receiver of the present teachings with coding at 5760 bits performs very close to an achievable-rate limit with a pragmatic rate triple of (2.67, 0.80, 0.40), in bits per symbol.

For ease of mathematical exposition, the satellites are assumed to have identical planar arrays with radiating elements that have the same radiation patterns. However, the radiating elements can form different patterns and be arranged differently onboard the satellites within the swarm. Moreover, the mathematical model applies a centralized satellite system in suppressing intra-beam interference, especially when full frequency reuse is utilized. A centralized satellite system hosting the overall number of radiating elements can be modeled as a distributed array system mathematical model by using Nₛ=1.

The receiver of the present teachings can be useful for many types of direct-to-device device terminals including cellular smartphones, tablets, fixed very-small aperture terminals (VSATs), in-vehicle scenarios or the like. Furthermore, the receiver can benefit D2D connectivity for the forward device link direction, from satellite to device, and in the return feeder link direction, from satellite to gateway, to recover the signals transmitted by device terminals.

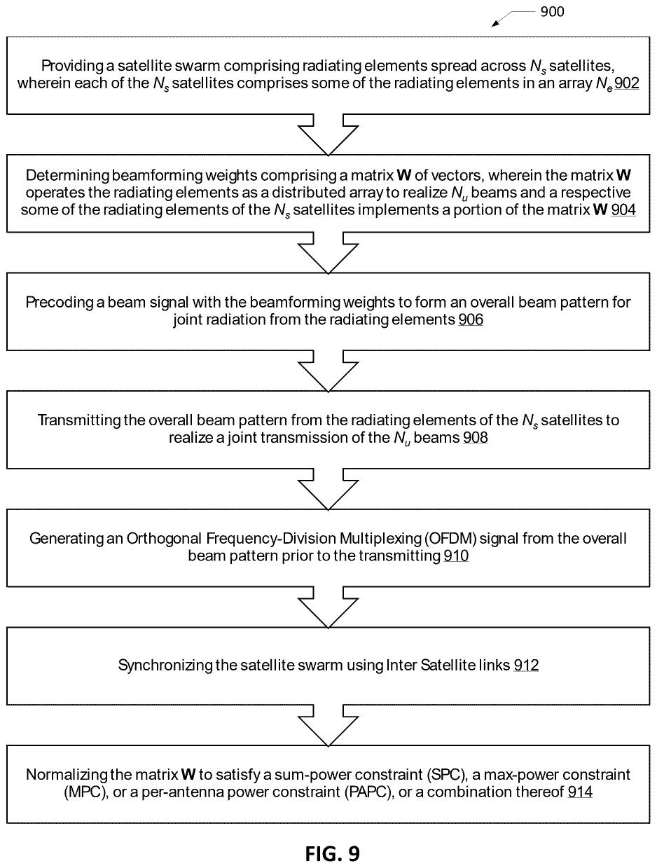

FIG. 9 illustrates a method 900 for beamforming according to various embodiments. Method 900 includes operation 902 for providing a satellite swarm including radiating elements spread across Nₛ satellites, wherein each of the Nₛ satellites includes some of the radiating elements in an array Nₑ. Method 900 includes operation 904 for determining beamforming weights including a matrix W of vectors, wherein the matrix W operates the radiating elements as a distributed array to realize Nᵤ beams and a respective some of the radiating elements of the Nₛ satellites implements a portion of the matrix W. Method 900 includes operation 906 for precoding a beam signal with the beamforming weights to form an overall beam pattern for joint radiation from the radiating elements. Method 900 includes operation 908 for transmitting the overall beam pattern from the radiating elements of the Nₛ satellites to realize a joint transmission of the Nᵤ beams. Method 900 includes operation 910 for generating an Orthogonal Frequency-Division Multiplexing (OFDM) signal from the overall beam pattern prior to the transmitting. Method 900 includes operation 912 for synchronizing the satellite swarm using Inter Satellite links Method 900 includes operation 914 for normalizing the matrix W to satisfy a sum-power constraint (SPC), a max-power constraint (MPC), or a per-antenna power constraint (PAPC), or a combination thereof.

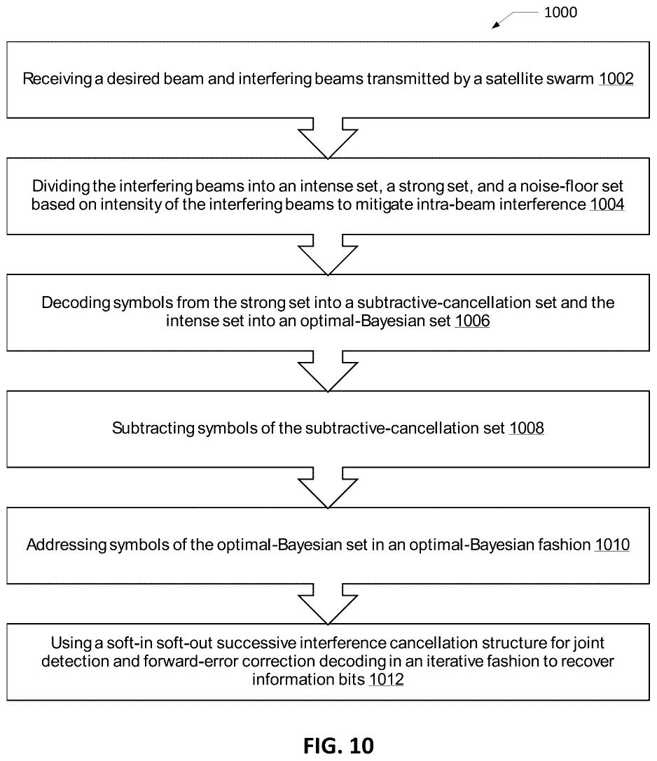

FIG. 10 illustrates a method 1000 for mitigating intra-beam interference according to various embodiments. Method 1000 includes operation 1002 for receiving a desired beam and interfering beams transmitted by a satellite swarm. Method 1000 includes operation 1004 for dividing the interfering beams into an intense set, a strong set, and a noise-floor set based on intensity of the interfering beams to mitigate intra-beam interference. Method 1000 includes operation 1006 for decoding symbols from the strong set into a subtractive-cancellation set and the intense set into an optimal-Bayesian set. Method 1000 includes operation 1008 for subtracting symbols of the subtractive-cancellation set. Method 1000 includes operation 1010 for addressing symbols of the optimal-Bayesian set in an optimal-Bayesian fashion. Method 1000 includes operation 1012 for using a soft-in soft-out successive interference cancellation structure for joint detection and forward-error correction decoding in an iterative fashion to recover information bits.

Although the subject matter has been described in language specific to structural features and/or methodological acts, it is to be understood that the subject matter in the appended claims is not necessarily limited to the specific features or acts described above. Rather, the specific features and acts described above are disclosed as example forms of implementing the claims. Other configurations of the described embodiments are part of the scope of this disclosure. Further, implementations consistent with the subject matter of this disclosure may have more or fewer acts than as described or may implement acts in a different order than as shown. Accordingly, the appended claims and their legal equivalents should only define the invention, rather than any specific examples given.

I claim as my invention:

1. A method for mitigating intra-beam interference, the method comprising:
receiving a desired beam and interfering beams transmitted by a satellite swarm;
dividing the interfering beams into an intense set, a strong set, and a noise-floor set based on intensity of the interfering beams to mitigate intra-beam interference;
decoding symbols from the strong set into a subtractive-cancellation set and the intense set into an optimal-Bayesian set;
subtracting symbols of the subtractive-cancellation set; and
addressing symbols of the optimal-Bayesian set in an optimal-Bayesian fashion,
wherein the desired beam and the interfering beams comprise an Orthogonal Frequency-Division Multiplexing (OFDM) transmission precoded with beamforming weights.

2. The method of claim 1, wherein the beamforming weights comprise a matrix W=[w₁, w₂, . . . , w_{N}_{ᵤ}]∈ [symbol] representing Nᵤ beams, each feeding radiating elements of the satellite swarm (NₛNₑ), the matrix W comprises vectors wᵢ∈ [symbol] , each of the vectors comprises a complex-valued weight vector
$${\underline{w}}_{i} = {[ {( {w}_{i}^{( 1 )} )}^{T} , {( {w}_{i}^{( 2 )} )}^{T} , … , {( {w}_{i}^{( {N}_{s} )} )}^{T} ]}^{T} ∈ {ℂ}^{( {N}_{s} {N}_{e} ) \times 1} ,$$
where
$${\underline{w}}_{l}^{( s )} ∈ {ℂ}^{{N}_{e} \times 1}$$
for a respective satellite of the Nₛ satellites.

3. The method of claim 2, wherein the matrix W is based on criteria comprising one or more of maximum-ratio transmission (MRT), zero-forcing (ZF), regularized ZF (RZF), minimum mean-square error (MMSE), maximum signal-to-leakage-and-noise-ratio (SLNR), or a combination thereof.

4. The method of claim 1, wherein the intense set comprises the interfering beams with highest intensity among the interfering beams, wherein the strong set comprises the interfering beams with intermediate intensity among the interfering beams, and wherein the noise-floor set comprises interfering beams with lowest intensity among the interfering beams.

5. The method of claim 1, wherein the subtractive-cancellation set comprises strong interferer sources and the optimal-Bayesian set comprises intense interferer sources.

6. The method of claim 1, wherein elements of the noise-floor set are incorporated through their powers, elements of the subtractive-cancellation set are incorporated via first-order and second-order moments computed from a priori probabilities, and the optimal-Bayesian set uses a priori probability mass function of interfering symbols.

7. The method of claim 1, further comprising using a modular structure to mitigate interference terms with computational power commensurate with a level of interference experienced, with a strength of a transmitted modulation/coding format, or a combination thereof.

8. The method of claim 1, further comprising using a soft-in soft-out successive interference cancellation structure for joint detection and forward-error correction decoding in an iterative fashion to recover information bits.

9. The method of claim 1, wherein the receiving is performed by a low-power omnidirectional antenna, and the desired beam and the interfering beams comprise an S-band carrier.

10. The method of claim 1, wherein the satellite swarm comprises radiating elements distributed across a plurality of satellites disposed in a logarithmic spiral array (LSA) in a low Earth orbit, and the radiating elements of the satellite swarm operate as a distributed array.

11. A system to mitigate intra-beam interference, the system comprising:
an antenna configured to receive a desired beam and interfering beams transmitted by a satellite swarm; and
a processor configured to:
divide the interfering beams into an intense set, a strong set, and a noise-floor set based on intensity of the interfering beams to mitigate intra-beam interference,
decode symbols from the strong set into a subtractive-cancellation set and the intense set into an optimal-Bayesian set,
subtract symbols of the subtractive-cancellation set, and
address symbols of the optimal-Bayesian set in an optimal-Bayesian fashion,
wherein the desired beam and the interfering beams comprise an Orthogonal Frequency-Division Multiplexing (OFDM) transmission precoded with beamforming weights.

12. The system of claim 11, wherein the beamforming weights comprise a matrix W=[w₁, w₂, . . . , w_{N}_{ᵤ}]∈ [symbol] representing Nᵤ beams, each feeding radiating elements of the satellite swarm (NₛNₑ), the matrix W comprises vectors wᵢ∈ [symbol] , each of the vectors comprises a complex-valued weight vector
$${\underline{w}}_{i} = {[ {( {w}_{i}^{( 1 )} )}^{T} , {( {w}_{i}^{( 2 )} )}^{T} , … , {( {w}_{i}^{( {N}_{s} )} )}^{T} ]}^{T} ∈ {ℂ}^{( {N}_{s} {N}_{e} ) \times 1} ,$$
where
$${\underline{w}}_{l}^{( s )} ∈ {ℂ}^{{N}_{e} \times 1}$$
for a respective satellite of the Nₛ satellites.

13. The system of claim 12, wherein the matrix W is based on criteria comprising one or more of maximum-ratio transmission (MRT), zero-forcing (ZF), regularized ZF (RZF), minimum mean-square error (MMSE), maximum signal-to-leakage-and-noise-ratio (SLNR), or a combination thereof.

14. The system of claim 11, wherein the intense set comprises the interfering beams with highest intensity among the interfering beams, wherein the strong set comprises the interfering beams with intermediate intensity among the interfering beams, and wherein the noise-floor set comprises interfering beams with lowest intensity among the interfering beams.

15. The system of claim 11, wherein the subtractive-cancellation set comprises strong interferer sources and the optimal-Bayesian set comprises intense interferer sources.

16. The system of claim 11, wherein elements of the noise-floor set are incorporated through their powers, elements of the subtractive-cancellation set are incorporated via first-order and second-order moments computed from a priori probabilities, and the optimal-Bayesian set uses a priori probability mass function of interfering symbols.

17. The system of claim 11, wherein the processor is further configured to use a modular structure to mitigate interference terms with computational power commensurate with a level of interference experienced, with a strength of a transmitted modulation/coding format, or a combination thereof.

18. The system of claim 11, wherein the processor is further configured to use a soft-in soft-out successive interference cancellation structure for joint detection and forward-error correction decoding in an iterative fashion to recover information bits.

19. The system of claim 11, wherein the antenna is a low-power omnidirectional antenna, and the desired beam and the interfering beams comprise an S-band carrier.

20. The system of claim 11, wherein the satellite swarm comprises radiating elements distributed across a plurality of satellites disposed in a logarithmic spiral array (LSA) in a low Earth orbit, and the radiating elements of the satellite swarm operate as a distributed array.
